(19) United States
(12) Patent Application Publication
(10) Pub. No.: US 2008/0290731 A1
(43) Pub. Date: Nov. 27, 2008

(54) Energy Efficient Power Supply

(76) Inventor: Tim Cassidy, Plymouth, MN (US)

Correspondence Address: SoCAL IP LAW GROUP LLP, 310 N. WESTLAKE BLVD. STE 120, WESTLAKE VILLAGE, CA, 91362, US

(21) Appl. No.: 12/186,464

(22) Filed: Aug. 5, 2008

Related U.S. Application Data
(63) Continuation of application No. 12/062,881, filed on Apr. 4, 2008.
(60) Provisional application No. 60/910,766, filed on Apr. 9, 2007.

(51) Int. Cl. H01H 83/00; H02J 7/00

(52) U.S. Cl. 307/35; 320/107; 307/125

(57) ABSTRACT

There is disclosed a power supply, a system, and method. A power supply may include a power converter for converting AC primary power into DC power, an internal load, and a DC power plug for delivering DC power from the power supply to a load external to the power supply. The power converter may include a standby circuit to place the power converter into a low power quiescent operating mode. A switch may be integrated into the DC power plug, the switch having an operate state and a standby state. The switch may control the flow of power from the power converter to the internal load.

### RELATED APPLICATION INFORMATION

This patent is a continuation-in-part of application Ser. No. 12/062,881, filed Apr. 4, 2008, entitled “Energy Efficient Power Converter”, which claims benefit of the filing date of provisional patent application Ser. No. 60/910,766, filed Apr. 9, 2007, entitled “Energy Efficient Power Converter”.

### NOTICE OF COPYRIGHTS AND TRADE DRESS

A portion of the disclosure of this patent document contains material which is subject to copyright protection. This patent document may show and/or describe matter which is or may become trade dress of the owner. The copyright and trade dress owner has no objection to the facsimile reproduction by anyone of the patent disclosure as it appears in the Patent and Trademark Office patent files or records, but otherwise reserves all copyright and trade dress rights whatsoever.

### BACKGROUND

1. Field

This disclosure relates to power converters.

2. Description of the Related Art

Power supplies are commonly used to provide power to a variety of fixed and mobile electronic devices including laptop computers, monitors, printers, cell phones, and other equipment. Power supplies may provide power to charge batteries within the equipment and/or power to operate the equipment.

FIG. 1 is a block diagram of a conventional power supply 100 that accepts AC line power through a plug P1 and provides DC power to a load device through a DC power plug 160. AC power plug P1 may be connected to the power supply 100 by a cable, or may be integrated into the housing of the power supply 100. The power supply 100 may be connected to the DC power plug 160 via a two-wire cord 130. The DC power plug 160 may mate with a receptacle 170 which may be a portion of or connected to a load (not shown). Alternatively, the receptacle 170 may be within or coupled to a dock. When the receptacle 170 is within or coupled to a dock, the power supply 100 may deliver power to the load device when the load device is plugged into or set upon the dock.

The power supply 100 may include a power converter 105 to convert AC primary power into a DC voltage. The power converter 105 may include a primary side 110 coupled to a secondary side 120 by a power transformer T1. The primary side 110 and the secondary side 120 may be isolated from each other by the power transformer T1. The primary side 110 may contain a rectifier to rectify the AC input voltage, high frequency switching circuitry to drive the primary side of transformer T1, and control circuitry, all of which are not shown in FIG. 1. The primary side 110 may contain a known high frequency switching circuit such as bridge, half-bridge, bootstrap, and other switching circuits.

The secondary side 120 may include circuitry (not shown) to rectify and filter the high frequency AC voltage from the secondary side of transformer T1 to provide a DC output voltage to the load. The secondary side 120 may include diode rectifiers or synchronous rectifiers. The secondary side 120 may include circuitry to sense the DC output voltage and/or the DC output current provided to the load. The secondary side may conventionally provide feedback signals to control circuits in the primary side to regulate either the DC output voltage and/or the DC output current.

The primary side 110 and the secondary side 120 may include one or more sensing circuits (not shown) to sense one or more potentially hazardous conditions such as output over-current, output over-voltage and/or input under-voltage. The primary side 110 may include a shut down circuit (not shown) to shut down the operation of the power converter in the event that one of these or other potentially hazardous conditions are sensed. Sensing circuits and shut down circuits are well known in the art and commonly included in power supplies and in power supply control integrated circuits.

Power supplies are commonly continuously connected to the AC power supply. In this case, the total energy consumed by the power supply when the load equipment is not connected may greatly exceed the energy actually delivered to the load equipment. New regulations in the United States, Europe, and elsewhere place stringent limits on the amount of power that may be consumed by an unloaded power supply. To limit the energy consumed by an unloaded power supply, the primary side 110 of contemporary power supplies may include a no-load standby circuit 115 to place the power supply in a low power quiescent mode of operation when the output of the secondary side is not connected to a load. The low power quiescent mode may be, for example, a so-called “skip mode”. During skip mode operation, when the secondary side 120 is not connected to a load, the primary side 110 may send energy through the power transformer T1 to the secondary side 120 only intermittently. This intermittent flow of energy may reduce the total amount of energy consumed by the power supply 100.

The power supply 100 may include an internal load 140 connected to the secondary side 120. The internal load 140 may be, for example, one or more LEDs indicating the status of the power supply. For further example, the internal load 140 may be a battery charge controller or other circuitry. The internal load 140 may consume energy unnecessarily when the power supply is not connected to an external load. In some applications, the internal load 140, by constantly drawing power from the power converter 105, may inhibit the no-load standby circuit from placing the power supply into the low power quiescent mode.

Within this description, the term “internal load” will refer to power-consuming circuits or components on the secondary side within the power supply, and the term “external load” will refer to a load device external to the power supply.

### DESCRIPTION OF THE DRAWINGS

FIG. 1 is a block diagram of a conventional prior art power supply.

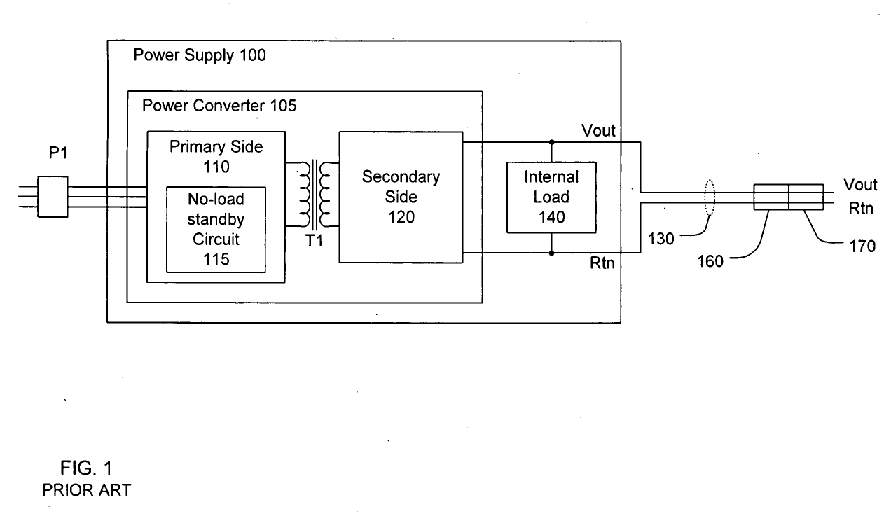

FIG. 2 is a block diagram of an energy-efficient power supply.

FIG. 3 is a block diagram of an energy-efficient power supply.

FIG. 4 is a block diagram of an energy-efficient power supply.

FIG. 5 is a block diagram of an energy-efficient power supply.

FIG. 6 is a block diagram of an energy-efficient power supply.

FIG. 7 is a schematic cross-sectional view of an exemplary integrated power plug and switch.

FIG. 8 is a schematic cross-sectional view of an exemplary integrated power plug and switch.

FIG. 9 is a flow chart of a process for operating a power supply.

Throughout this description, elements appearing in figures are assigned three-digit reference designators, where the most significant digit is the figure number and the two least significant digits are specific to the element. An element that is not described in conjunction with a figure may be presumed to have the same characteristics and function as a previously-described element having a reference designator with the same least significant digits.

### DETAILED DESCRIPTION

Description of Apparatus

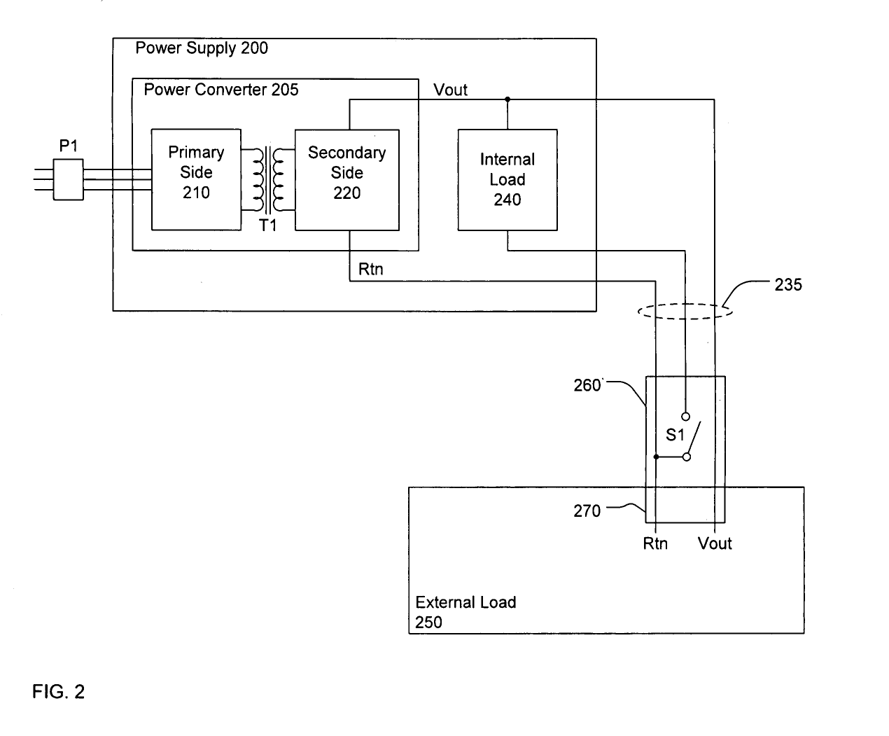

FIG. 2 is block diagram of a power supply 200 which may include a power converter 205 and an internal load 240. The power converter 205 may include a primary side 210 and secondary side 220. The primary side 210 may receive AC power through a first plug P1. The primary side 210 and the secondary side 220 may be electrically isolated and coupled by a power transformer T1. The secondary side 220 may deliver DC power to an external load 250 through a DC power plug 260 which includes an integrated switch S1. The external load may be, for example, an item of portable electronic equipment such as a cell phone, a PDA, a portable audio/video player, a camera, or a portable computer. The external load may be, for further example, an item of electronic equipment such as an audio system, a printer or other computer peripheral, or any other electronic equipment using an external power supply.

The switch S1 may have an “operate” state and a “standby state”. The operate state may indicate the DC power plug 260 is connected to the external load 250. The standby state may indicate that the DC power plug 260 is not connected to the external load 250. In one embodiment, the switch S1 is open when the DC power plug 260 is not connected to the external load 250 and closed when the DC power plug 260 is connected to the external load 250.

The power supply 200 may be connected to the DC power plug 260 via a three-wire cord 235. The DC power plug 260 may be physically plugged into a receptacle 270 that may be a portion of or coupled to the external load device. Alternatively, the receptacle 270 may be within or coupled to a dock. When within or coupled to a dock, the power supply 200 may deliver power to the external load 250 when the external load device is plugged into or set upon the dock.

The cord 235 may have three or more wires. Two wires in the cord 235 may deliver power to a load, and a third wire may connect to a switch S1 integrated into the DC power plug 260. The switch S1 may be normally open when the DC power plug 260 is not engaged with the external load. The switch S1 may be closed when the DC power plug 260 is engaged with the external load.

The switch S1 may control the application of power to the internal load 240. In the example of FIG. 2, the switch S1 may interrupt a return (Rtn) or ground connection between the internal load 240 and the secondary side 220 when the DC power plug 260 is not connected to the receptacle 270. The switch S1 may close and thus complete the return connection between the internal load 240 and the secondary side 220 when the DC power plug 260 is connected to the receptacle 270.

The switch S1 may be a device that has electrically open and electrically closed states that may indicate if the DC power plug 260 is connected or is not connected to an external load. The switch S1 may or may not include one or more components that move mechanically when the DC power plug 260 is connected or disconnected from the external load. The switch S1 may be two terminals that may be electrically connected by a pin or other electrical conductor which may be a portion of or included with the mating receptacle 270. When the DC power plug 260 is connected to the mating receptacle 270, the pin or other electrical conductor may complete an electrical circuit between two terminals of the DC power plug 270.

The DC power plug 260 and the integrated switch S1 may be adapted to mate with a conventional receptacle J3 that may be, for example, a portion of an existing equipment. The DC power plug 260 and the switch S1 may be adapted to perform the described functions without requiring additional or extraneous pins or other electrical contacts in the mating receptacle 270. Thus the power supply 200 may be used with “of the shelf”, existing and readily available external load devices.

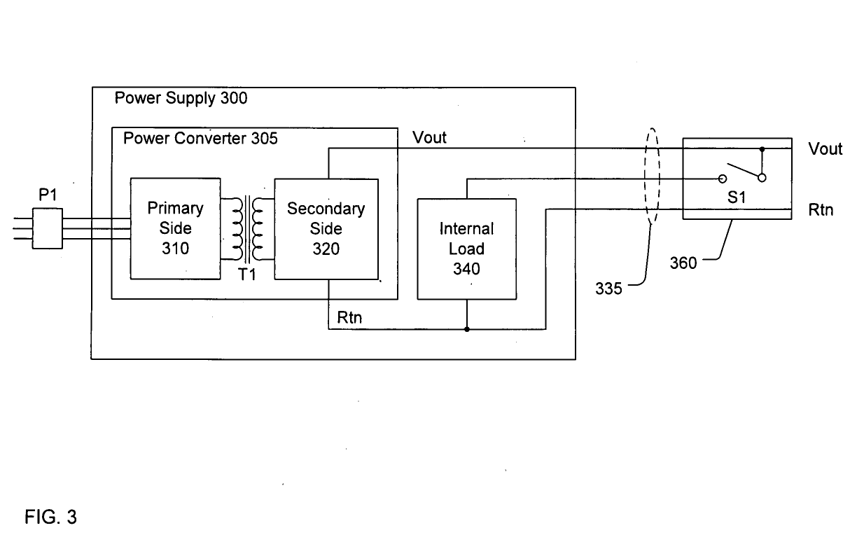

FIG. 3 is a block diagram of a power supply 300 having essentially the same elements as the power supply 200. In the example of FIG. 3, the switch S1 may interrupt an output voltage (Vout) connection between an internal load 340 and a secondary side 320 when the DC power plug 360 is not connected to an external load. The switch S1 may close and thus complete the output voltage connection between the internal load 340 and the secondary side 320 when the DC power plug 360 is connected to an external load.

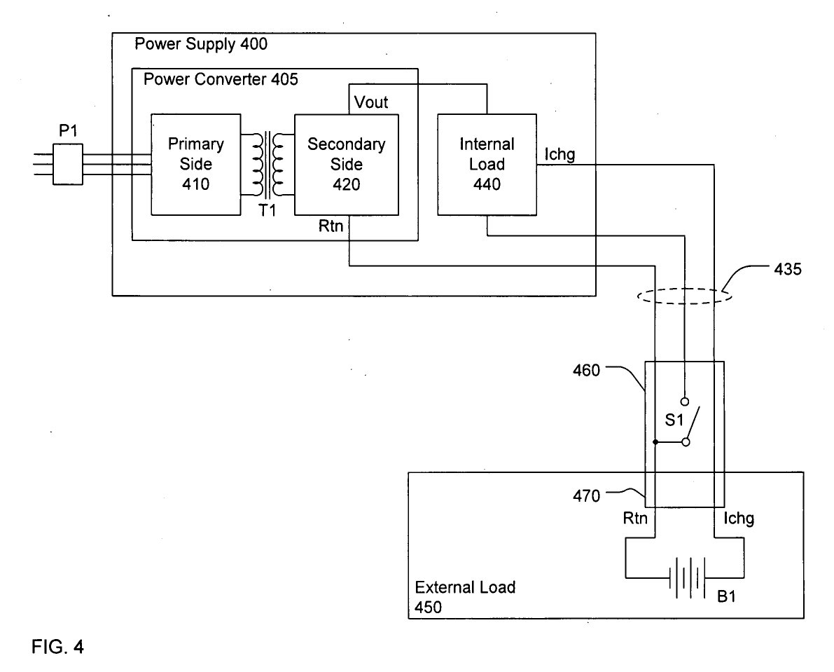

FIG. 4 is a block diagram of a power converter 400 which may include a power converter 405 and an internal load 440. The power converter 405 may include a primary side 410 and secondary side 420. The primary side 410 and the secondary side 420 may be electrically isolated and coupled by a power transformer T1. The secondary side 420 may deliver DC power to a load through, or under control of, an internal load 440. The internal load 440 may be, for example a battery charge controller or other circuit. Within this description, a battery charge controller is a circuit that is powered by a DC voltage and provides a controlled current for charging a battery. A battery charge controller may be embodied in a single integrated circuit, discrete components, or a combination of one or more integrated circuits and/or discrete components.

When the internal load 440 is a battery charge controller, a DC charging current Ichg may be delivered to an external load 450 which includes a battery B1. The DC charging current may be delivered to the external load 450 through a three-wire cord 435 and a DC power plug 460. The DC power plug 460 may include an integrated switch S1. The switch S1 may be open when the DC power plug 460 is not connected to the external load 450 and closed when the DC power plug 460 is connected to the external load 450.

The switch S1 may control the application of power to the internal load/battery charge controller 440. In the example of FIG. 4, the switch S1 may interrupt a return (Rtn) or ground connection between the internal load 440 and the secondary side 420 when the DC power plug 460 is not connected to an external load 450. The switch S1 may close and thus complete the return connection between the internal load 440 and the secondary side 420 when the DC power plug 460 is connected to the external load 450.

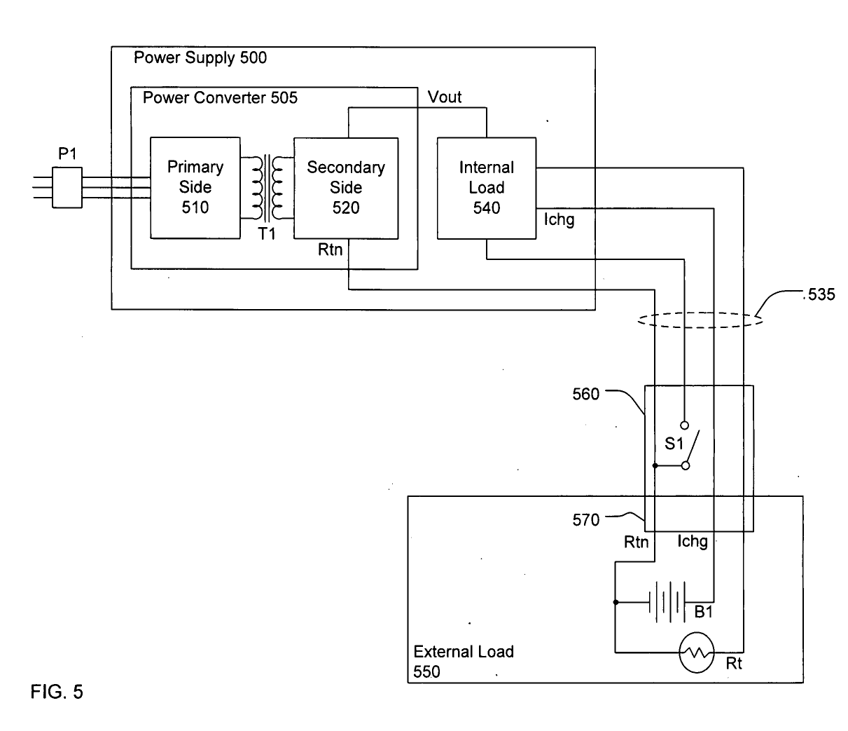

FIG. 5 is a block diagram of a power supply 500 having essentially the same elements as the power supply 400. In the example of FIG. 5, the switch S1 may interrupt a return connection (Rtn) between the secondary side 520 and the internal load 540 when a DC power plug 560 is not connected to an external load 550. The switch S1 may close and thus complete the output voltage connection between the internal load 540 and the secondary side 520 when the DC power plug 560 is connected to the external load 550.

The cord 535 may have more than three wires. For example, the cord 535 may have a fourth wire that provides a connection between the internal load 540 and a sensor Rt that indicates the temperature of the battery B1 during charging.

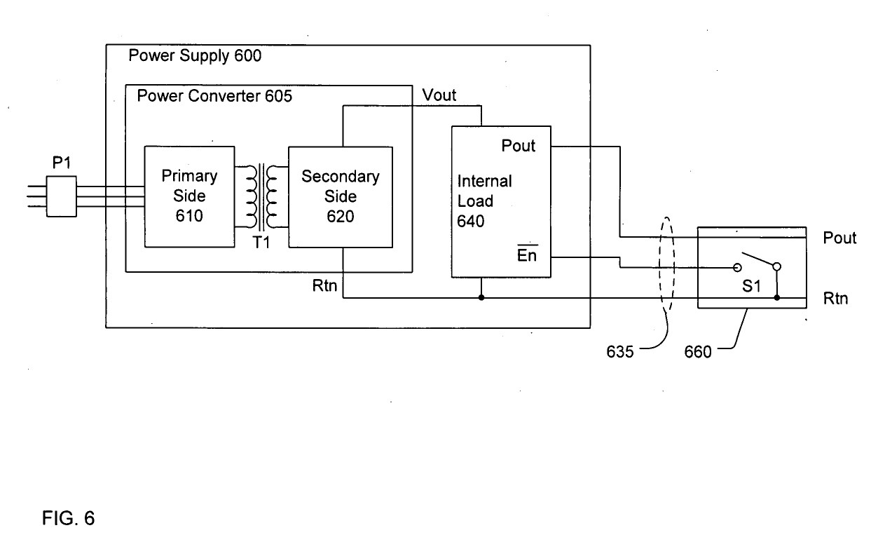

FIG. 6 is a block diagram of a power converter 600 which includes a primary side 610 and secondary side 620. The primary side 610 and the secondary side 620 may be electrically isolated from each other and coupled by a power transformer T1. The secondary side 620 may deliver DC power to a load through, or under control of, an internal load 640. The internal load 640 may be, for example a battery charge controller or other circuit. DC power Pout may be delivered to an external load (not shown) through a three-wire cord 635 and a DC power plug 660 which includes an integrated switch S1. The switch S1 may be open when the DC power plug 660 is not connected to the external load and closed when the DC power plug 660 is connected to the external load.

The switch S1 may provide a logical input to the internal load 640. The switch S1 may break a connection between an enable input En to the internal load 640 and Rtn when the DC power plug 660 is not connected to the external load. Breaking the connection between the enable input En and Rtn may place the internal load 640 in a low power quiescent operating mode. When the DC power plug 660 is connected to a load, the switch S1 may close to complete a connection between the enable input En and Rtn. Completing the connection between the enable input En and Rtn may place the internal load into an operating state and cause the internal load to deliver power to the external load.

In each of the power supplies 200, 300, 400, 500, and 600, the opening of switch S1 when a DC power plug 260, 360, 460, 560, 660 is not connected to an external load may be effective to control the flow of power from a power converter to an internal load. Opening the switch S1 may eliminate or substantially reduce the power consumption of the internal load. Reducing the power consumption of the internal load may, in turn, allow a primary-side standby circuit (such as standby circuit 115) to place the power converter 205, 305, 405, 505, 605 into a low power quiescent mode.

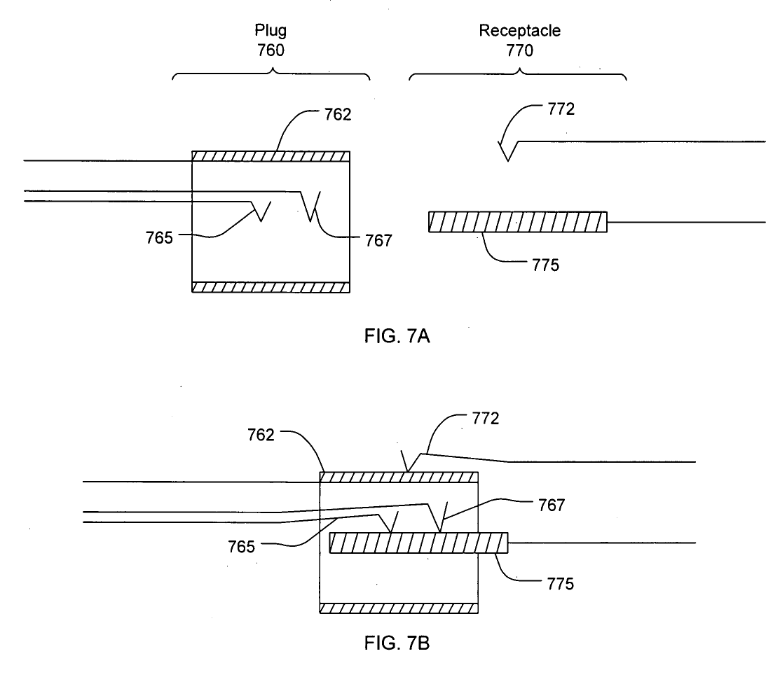

FIG. 7A and FIG. 7B are schematic cross-sectional views of an exemplary integrated DC power plug and switch 760 which may be used as the plug P3 in a power converter as described in FIGS. 2, 3, 4, 5, and 6. FIG. 7A and FIG. 7B are intended to represent a common type of DC power plug, but are not drawn in proportion or to scale. FIG. 7A and FIG. 7B show the conductive portions of the DC power plug 760 and a mating receptacle 770, but do not show the insulating material that supports and separates the conductive portions.

Referring to FIG. 7A, the unmated DC power plug 760 may be comprised of a conductive barrel 762 (shown in cross section) and two spring contacts 765 and 767 that are electrically isolated from each other and the barrel 762. The mating receptacle 770 may be comprised of conductive pin 775 and spring contact 772.

Referring to FIG. 7B, when mated, the barrel 762 may be electrically connected to spring contact 772. The pin 775 may be electrically connected to both spring contacts 765 and 767. Thus spring contact 765 and 767 may function as a normally-open switch that is “closed” by the insertion of pin 775. The path through barrel 762 and spring contact 772 and the path through pin 775 and either spring contact 765 or 767 may be used to deliver power to an external load equipment.

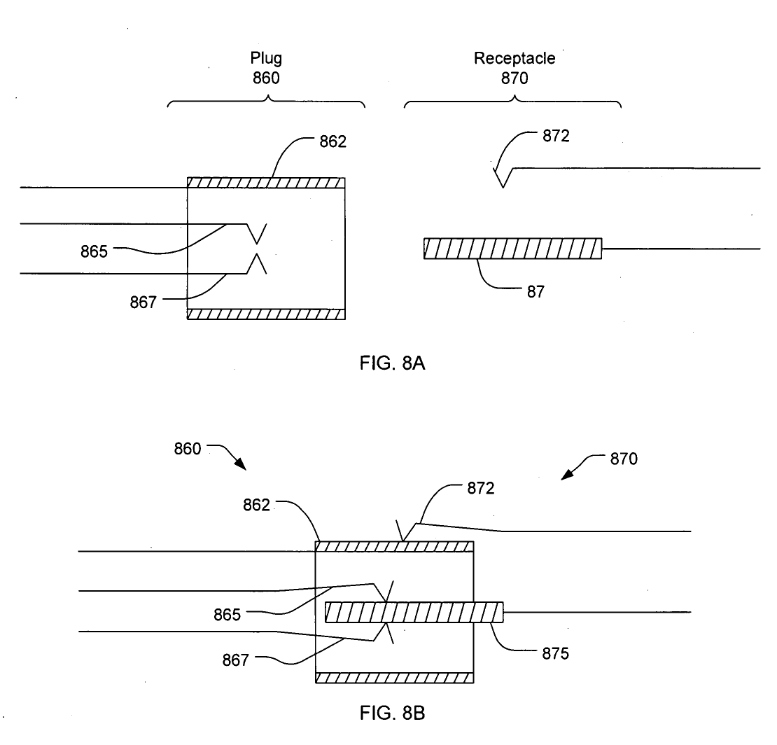

FIG. 8A and FIG. 8B show the conductive portions of a DC power plug 860 and a mating receptacle 870 which may be used as the plug in a power converter as described in FIGS. 2, 3, 4, 5, and 6. FIG. 8A and FIG. 8B are intended to represent a common type of DC power plug, but are not drawn in proportion or to scale. FIG. 8A and FIG. 8B show the conductive portions of the DC power plug 860 and a mating receptacle 870, but do not show the insulating material that supports and separates the conductive portions. The DC power plug 860 and the mating receptacle 870 are similar to the DC power plug 760 and mating receptacle 770 of FIG. 6 except that spring contacts 865, 867 contact diametrically opposed portions of pin 875 when the plug 860 and receptacle 870 are mated (as shown in FIG. 8B).

The integrated DC power plug and switches 760, 860 and the mating receptacles 770, 870 are exemplary and many other plug/switch and receptacle devices may be used. The receptacles 770, 870 may be a conventional receptacle that is part of an existing electronic device, and the integrated DC power plug and switch may be adapted to mate with an existing receptacle.

Description of Processes

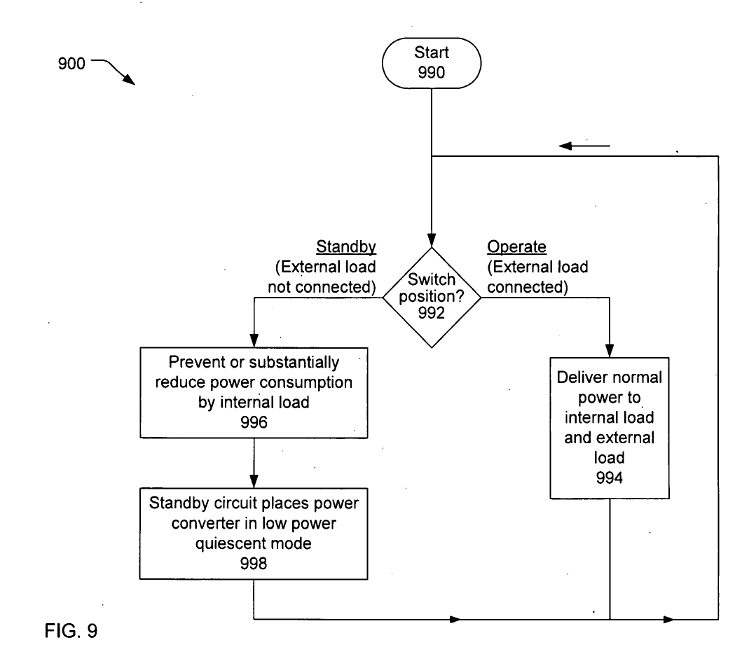

Referring now to FIG. 9, a process 900 for operating a power supply, which may be a power supply such as power supplies 200, 300, 400, 500, and 600, may start at 990 when the power supply is attached to an AC primary power supply. At 992, the state of a switch may be detected. The switch may be integrated into a power plug that delivers DC power to an external load. The switch state may indicate if the power plug is connected to the external load.

The state of the switch may be detected by determining if the switch is in either a “closed” state that allows electrical current to flow through the switch or an “open” state that does not allow the flow of electrical current. In one embodiment, the closed state may be functionally equivalent an “operate” state indicating that the power plug is connected to the external load, and the open state may be functionally equivalent to a “standby” state indicating that the power plug is not connected to the external load. The opposite functional definitions for the open and closed states may also be used.

If the switch is in the “operate” state indicating that the power plug is connected to the external load, the power supply may deliver normal DC power to the external load and to an internal load at 994. If the switch is in the “standby” state indicating that the power plug is not connected to the external load, the power delivered to the internal load may be cut off or substantially reduced at 996. In this context, a “substantial” reduction in the power delivered to the load may be a reduction to a level of power consumption that does not preclude a standby circuit within the power supply causing a power converter within the power supply to enter a low power quiescent operating mode at 998. Alternatively, a “substantial” reduction in the power delivered to the load may be a reduction to a level of power consumption that allows the power supply to meet or conform to regulatory limits on the amount of power that may be consumed by an unloaded power supply.

The process may repeat continuously from 992 so long as the power supply is connected to the AC primary power supply. While the process has been conveniently shown and described in terms of sequential actions, the sensing of the switch state at 992 and either quiescent operation (996, 998) or the normal operation (994) may occur essentially simultaneously and continuously.

Closing Comments

Throughout this description, the embodiments and examples shown should be considered as exemplars, rather than limitations on the apparatus and procedures disclosed or claimed. Although many of the examples presented herein involve specific combinations of method acts or system elements, it should be understood that those acts and those elements may be combined in other ways to accomplish the same objectives. With regard to flowcharts, additional and fewer steps may be taken, and the steps as shown may be combined or further refined to achieve the methods described herein. Acts, elements and features discussed only in connection with one embodiment are not intended to be excluded from a similar role in other embodiments.

For means-plus-function limitations recited in the claims, the means are not intended to be limited to the means disclosed herein for performing the recited function, but are intended to cover in scope any means, known now or later developed, for performing the recited function.

As used herein, “plurality” means two or more.

As used herein, a “set” of items may include one or more of such items.

As used herein, whether in the written description or the claims, the terms “comprising”, “including”, “carrying”, “having”, “containing”, “involving”, and the like are to be understood to be open-ended, i.e., to mean including but not limited to. Only the transitional phrases “consisting of” and “consisting essentially of”, respectively, are closed or semi-closed transitional phrases with respect to claims.

Use of ordinal terms such as “first”, “second”, “third”, etc., in the claims to modify a claim element does not by itself connote any priority, precedence, or order of one claim element over another or the temporal order in which acts of a method are performed, but are used merely as labels to distinguish one claim element having a certain name from another element having a same name (but for use of the ordinal term) to distinguish the claim elements.

As used herein, “and/or” means that the listed items are alternatives, but the alternatives also include any combination of the listed items.

It is claimed:

1. A power supply comprising:
a power converter for converting AC power into DC power, the power converter including a standby circuit to place the power converter into a quiescent operating mode
a DC power plug for delivering DC power from the power supply to a load external to the power supply
an internal load
a switch integrated into the DC power plug, the switch having an operate state and a standby state
wherein the switch controls the flow of power from the power converter to the internal load.

2. The power supply of claim 1, wherein
when the switch is in the standby state, the power delivered to the internal load is substantially reduced and the standby circuit places the power converter into the quiescent operating mode, and
when the switch is in the operate state, power is delivered normally to the internal load.

3. The power supply of claim 1, wherein
when the DC power plug is connected to the external load, power is delivered normally to the external load and to the internal load
when the DC power plug is disconnected from the external load, the switch causes the power delivered to the internal load to be substantially reduced and the standby circuit places the power converter into the quiescent operating mode.

4. The power supply of claim 1, wherein
the standby state of the switch indicates the DC power plug is not engaged with the external load, and
the operate state of the switch indicates DC power plug is engaged with the external load.

5. The power supply of claim 1, wherein
the switch is open in the standby state, and
the switch is closed in the operate state.

6. The power supply of claim 5, wherein the switch opens and closes one of a power connection, a ground connection, or an enable input to the internal load.

7. The power supply of claim 1, wherein the internal load is a battery charge controller.

8. The power supply of claim 1, wherein the internal load comprises at least one light emitting diode.

9. A battery charger comprising:
a power converter for converting AC power into DC power, the power converter including a standby circuit to place the power converter into a low power quiescent operating mode
a DC power plug for delivering a battery charging current from the power supply to an electronic device containing a rechargeable battery
a battery charge controller to control the charging current
a switch integrated into the DC power plug, the switch having a standby state and an operate state
wherein the switch controls the flow of power from the power converter to the battery charge controller.

10. The battery charger of claim 9, wherein
the switch is in the standby state when the DC power plug is not engaged with the electronic device, and
the switch is in the operate state when the DC power plug is engaged with the electronic device.

11. The battery charger of claim 9, wherein
the switch is open in the standby state, and
the switch is closed in the operate state.

12. The battery charger of claim 11, wherein
when the switch is open, the power delivered to the battery charge controller is substantially reduced and the standby circuit places the power converter into the low power quiescent operating mode.

13. The battery charger of claim 12, wherein the switch opens and closes one of a power connection, a ground connection, or an enable input to the battery charge controller.

14. A method of operating a power supply, comprising:
determining the state of a switch, wherein
the switch is integrated into a power plug for delivering electrical power from the power supply to a load external to the power supply
the switch has an operate state indicating that the power plug is engaged with the external load
the switch has a standby state indicating that the power plug is not engaged with the external load
substantially reducing power flow to an internal load within the power supply in response to a determination that the switch is in the standby state.

15. The method of claim 14, further comprising:
when the switch is in the standby state, placing a power converter within the power supply into a low power quiescent mode.

16. The method of claim 14, wherein the switch opens and closes one of a power connection, a ground connection, or an enable input to the internal load.

17. The method of claim 14, wherein the internal load is a battery charge controller.

18. The method of claim 14, wherein the internal load comprises at least one light emitting diode.

19. A system comprising:
a portable electronic device including
a rechargeable battery
a receptacle for receiving DC electrical power
a power supply comprising
a power converter for converting AC power into DC power, the power converter including a standby circuit to place the power converter into a low power quiescent operating mode
a DC power plug for delivering a charging current from the power supply to the receptacle
a battery charge controller to control the charging current
a switch integrated into the DC power plug, the switch having a standby state and an operate state
wherein the switch controls the flow of power from the power converter to the battery charge controller.
